(19) United States
(12) Patent Application Publication
(10) Pub. No.: US 2023/0243593 A1
(43) Pub. Date: Aug. 3, 2023

(54) HEAT EXCHANGER

(71) Applicant: Ian Richard SCOTT, Stratford on Avon, Warwickshire (GB)

(72) Inventor: Ian Richard SCOTT, Stratford on Avon, Warwickshire (GB)

(21) Appl. No.: 18/044,300

(22) PCT Filed: Sep. 1, 2021
(86) PCT No.: PCT/EP2021/074119

§ 371 Date: Mar. 7, 2023

(30) Foreign Application Priority Data
Sep. 8, 2020 (GB) 2014090.1

(51) Int. Cl. F28D 7/00; F28F 13/00; F28D 21/00

(52) U.S. Cl. CPC F28D 7/0033; F28F 13/00; F28D 21/00; F28D 2021/0054; F28F 2013/006; F28F 2265/16

(57) ABSTRACT

A heat exchanger. The heat exchanger comprises a plurality of primary fluid tubes configured to carry a primary fluid, a plurality of secondary fluid tubes configured to carry a secondary fluid, and a plurality of intervening layers, each intervening layer being thermally conductive and impermeable to both the primary and secondary fluids. Each intervening layer has one or more of the primary fluid tubes on a first side, and one or more of the secondary fluid tubes on a second side opposite the first side, such that the region between each pair of neighbouring intervening layers contains either primary fluid tubes or secondary fluid tubes, but not both primary and secondary fluid tubes.

### FIELD OF THE INVENTION

The present invention relates to heat exchangers. In particular, the present invention relates to a heat exchanger configured to prevent mixing of the primary and secondary fluid during a failure, e.g. for use in a nuclear reactor.

### BACKGROUND

The primary coolant in a nuclear reactor generally becomes radioactive due to neutron irradiation while it passes through the reactor core. It is desirable that this radioactivity cannot pass beyond the primary coolant into the secondary systems that convert the heat to power. However, the absence of breaches of the physical barriers between the primary coolant and secondary systems cannot be assured. As a result, many reactor designers insert an extra coolant loop between the primary coolant and the power generating systems. This ensures that failure of the heat exchangers linking those coolant loops cannot result in radioactive contamination of the power generating system. This step however comes at a considerable cost and an inevitable loss of efficiency as temperature is lost through the series of heat exchangers.

This problem is particularly acute in reactors where the chemistry of the coolants involved are incompatible. For example, sodium cooled reactors ultimately must pass their heat to water to produce steam, but sodium and water react violently if allowed to come into contact.

In reactors where the primary coolant is a molten salt, other problems occur. For example, a fluoride based primary coolant linked to a nitrate based secondary coolant is a popular option among reactor designers given the favourable reactor physics of fluoride salts and the utility of nitrate salts as low cost heat storage media. If the nitrate salt is at a higher pressure than the fluoride salt in the heat exchanger then nitrate can enter the primary coolant where it will cause major corrosion problems. Conversely, if the fluoride salt is at the higher pressure a heat exchanger leak will lead to highly radioactive material entering the nitrate salt system leading to radioactive contamination of large volumes of nitrate salt. It is normal therefore for designers to insert an extra loop between the two salts so that any leakage through any of the heat exchangers is into that extra loop which can be kept at the lowest pressure.

There is therefore a need for a design of heat exchanger where failure of the boundary of either fluid does not lead to contamination of the second fluid.

There are many designs of heat exchanger available including tube in shell, plate, plate and shell, wheel, microchannel and others. None meet the criterion of not allowing mixing of the fluids in the event of mechanical failure. Perhaps the lowest risk heat exchangers are the block type heat exchangers (https://www.gab-neumann.com/block-heat -exchangers) where a single rather thick material layer separates the two fluids. Nonetheless, a single failure of that material layer still allows mixing of the fluids.

Substantial effort was expended in attempting to devise safer heat exchangers for sodium cooled reactors. One option was to make the tubes in a tube in shell heat exchanger double walled, with a gas separating the wall exposed to the sodium from the wall exposed to water. These were effective but expensive and prone to failure. They were also inefficient as the gas gap resulted in poor thermal performance.

An earlier option, prototyped in the Dounreay Fast Reactor but seemingly lost to public knowledge apart from a reference in a foreign trip report by a visiting US scientist (L. M. Finch, BNWL-602, p5 https://www.osti.gov/servlets/purl/4571502) was an ingenious design where copper plates were drilled with four holes and two sodium pipes and two water pipes were inserted through the four holes. A large number of copper plates were stacked along each set of pipes and clamped. This formed an effective metal barrier between the sodium and water containing pipes. The design did work effectively, but burst water pipes had the effect of forcing the copper plates apart so the water, or rather steam, came directly into contact with the sodium pipe. Unless the failure was immediately detected, there was therefore the possibility that the steam and sodium could come into contact if a second pipe failure occurred.

We have devised a modified version of the Dounreay heat exchanger that reduces the possibility of mixing of the fluids to a negligible level and that is the subject of this invention.

### SUMMARY

According to an aspect of the present invention there is provided a heat exchanger. The heat exchanger comprises a plurality of primary fluid tubes configured to carry a primary fluid, a plurality of secondary fluid tubes configured to carry a secondary fluid, and a plurality of intervening layers, each intervening layer being thermally conductive and impermeable to both the primary and secondary fluids. Each intervening layer has one or more of the primary fluid tubes on a first side, and one or more of the secondary fluid tubes on a second side opposite the first side, such that the region between each pair of neighbouring intervening layers contains either primary fluid tubes or secondary fluid tubes, but not both primary and secondary fluid tubes.

### BRIEF DESCRIPTION OF THE DRAWINGS

FIG. 1 shows a cross section of an exemplary heat exchanger;

FIG. 2 shows arrangements of primary and secondary fluid tubes within a heat exchanger

### DETAILED DESCRIPTION

While the background has been described in the context of a nuclear reactor, it will be appreciated that there may be a need for heat exchangers to prevent mixing of the primary and secondary fluids in other applications, and the below description should not be taken as limited to nuclear reactors.

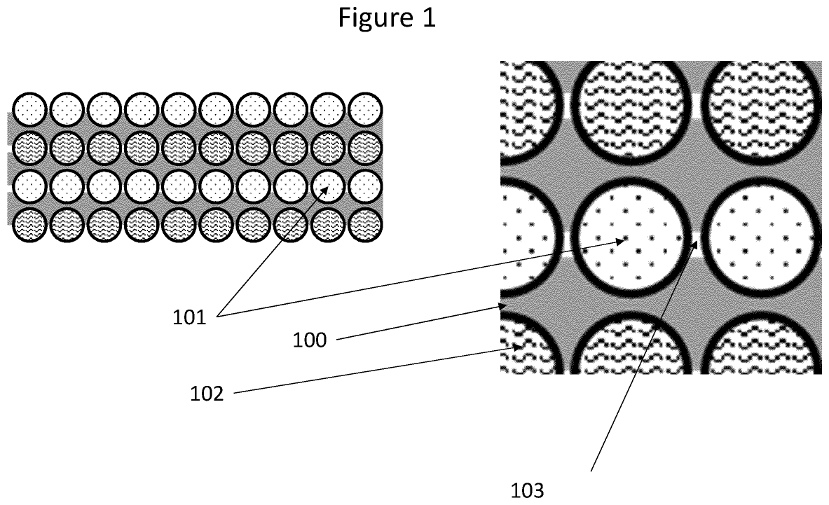

FIG. 1 illustrates an exemplary heat exchanger. Primary 101 and secondary 102 fluid tubes are arranged in alternating layers in the heat exchanger. Between each layer of tubes is an intervening layer 100 formed from a thermally conductive material that is impermeable to both fluids is positioned so that it is in close physical contact with both layers of tubes. The intervening material may be copper, aluminium, graphite, silicon carbide or other thermally conductive material depending on the nature of the fluids concerned. For molten salts at high temperatures, copper is a suitable material.

The shape of the intervening layer may be such that there is a small gap 103 between them bounded on two sides by two intervening layers and on at least one other side by the walls of one or more tubes within the same layer, which acts as a leakage channel as described in more detail below.

This arrangement functions as follows.

In normal operation the heat exchanger is highly efficient as the intervening layer is highly thermally conductive and heat transfer rate is dominated by the two fluid to tube heat transfer coefficients. Since heat transfer coefficient for the rapidly moving fluid in the tube is typically higher than that for the slower moving fluid in the shell of a tube in shell heat exchanger, this arrangement gives high thermal performance.

In the event of a failure of any tube, fluid from that tube leaks and the low resistance flow path may be through the channels formed by the gap between the intervening layers either side of the layer of tubes. These drain outside the heat exchanger so a failure is readily detected. Alternatively, such channels may be omitted and the fluid may be contained by the intervening layers. Most importantly however, whether or not such channels are provided, the leaking fluid does not come into contact with the alternating layer of tubes carrying the second fluid due to the impermeable layers separating them. For the two fluids to come into contact therefore requires a triple failure of both tubes carrying the two fluids and the intervening layer of material. The Dounreay heat exchanger in contrast had the intervening copper plates in a configuration where adjacent plates could be forced apart allowing direct contact between leaked fluid from one tube with the surface of adjacent tubes. Only two failures were necessary for fluids to mix.

The intervening layer of material can be manufactured by several process to have channels for the tubes but a particularly useful process is stamping of the material to create the channels. This is particularly useful where the intervening material is relatively soft, such as for copper and aluminium. Harder materials may have to have channels machined in their surfaces or be formed in the correct shape for ceramic type materials.

Multiple alternate layers of tubes and intervening material are clamped or otherwise pressed together to form a complete heat exchanger. Many arrangements of tube layers are possible as will be apparent to those of ordinary skill in the heat exchanger art, with the important factor being that where primary coolant tubes and secondary coolant tubes are in proximity, there is an intervening layer between them as described above, or equivalently that a region between each pair of neighbouring intervening layers comprises only primary coolant tubes, or only secondary coolant tubes, but not both.

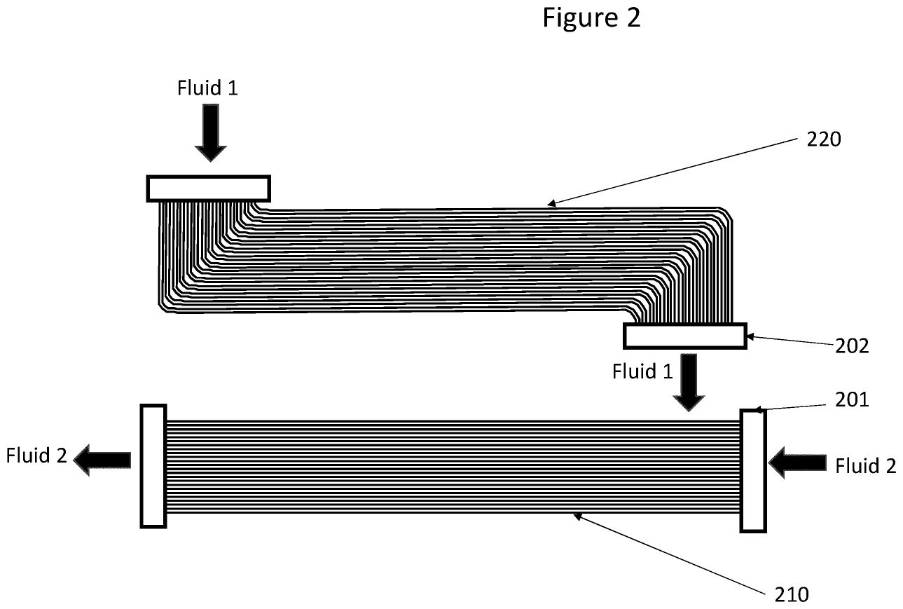

A counterflow heat exchanger with end plenums 201 for fluid 2 and side plenums 202 for fluid 1 is illustrated in FIG. 2. Twenty alternating layers of tubes as shown are stacked with stamped copper intervening plates as illustrated in FIG. 1 between each layer of tubes. The whole assembly of tubes and intervening plates are clamped together with a top and bottom strong steel plate for mechanical strength. Any leaked fluid from any tube appears in the short length of tube between the intervening plates and the tube sheet allowing them to be collected without the chance of mixing with the other fluid.

Fluid 1 in FIG. 2 may be either the primary or secondary coolant fluid, with the other being fluid 2. In general, for such a structure, the primary fluid tubes or the secondary fluid tubes comprises a first set of fluid tubes 210, and the other of the primary fluid tubes or the secondary fluid tubes comprises a second set of fluid tubes 220. The first set of fluid tubes are each straight and parallel to each other when passing through the heat exchanger, i.e. they have end plenums which remain parallel up to the plenum. The second set of fluid tubes each have an elongate section which is straight and parallel to the first set of fluid tubes, and inlet and outlet sections which are perpendicular to the first set of fluid tubes, i.e. they have side plenums.

In an alternative construction, rather than an array of fluid tubes within each layer, a single wide fluid tube may be provided which spans across a substantial proportion of the layer, acting as a plate-type heat exchanger. The fluid tubes may have an aspect ratio (i.e. a ratio between two perpendicular dimensions of a cross section perpendicular to their length) of approximately 1 (e.g. round or square tubes), or may have higher aspect ratios, e.g. at least 2 or at least 5 (e.g. oval or plate-type tubes).

The fluid tubes may have internal features to aid in heat transfer to and from the fluid, such as fins, or may have additional features to impart desired flow characteristics to the fluid.

Suitable materials for the fluid tubes include steel. Where the primary and/or secondary coolant fluid is a molten salt, the respective fluid tubes may be configured to carry the molten salt, for example being made from a material which resists corrosion by the molten salt, or having an internal coating to resist corrosion, and being made from a material with a melting point higher than the operating temperature of the molten salt.

1. A heat exchanger comprising:
a plurality of primary fluid tubes configured to carry a primary fluid;
a plurality of secondary fluid tubes configured to carry a secondary fluid;
a plurality of intervening layers, each intervening layer being thermally conductive and impermeable to both the primary and secondary fluids;
each intervening layer having one or more of the primary fluid tubes on a first side, and one or more of the secondary fluid tubes on a second side opposite the first side, such that the region between each pair of neighbouring intervening layers contains either primary fluid tubes or secondary fluid tubes, but not both primary and secondary fluid tubes, and such that wherever primary coolant tubes and secondary coolant tubes are in proximity, there is an intervening layer between them.

2. A heat exchanger according to claim 1, the heat exchanger further comprising a plurality of leakage channels, such that each of the primary and secondary fluid tubes forms the boundary to at least one leakage channel, the leakage channels being located between the neighbouring intervening layers.

3. A heat exchanger according to claim 2, and comprising a fault detection system configured to detect the primary fluid and the secondary fluid in the plurality of leakage channels, and to provide a signal indicating that a fault is present if either the primary fluid or the secondary fluid is detected in any of the leakage channels.

4. A heat exchanger according to claim 1, wherein the intervening layers are formed from one or more of:
copper;
aluminium;
graphite;
silicon carbide.

5. A heat exchanger according to claim 1, wherein each intervening layer comprises a plurality of channels, and the primary and secondary fluid tubes rest in the channels of the neighbouring intervening layers.

6. A heat exchanger according to claim 1, wherein inlets and outlets of the primary fluid tubes are located on a first set of external faces of the heat exchanger, and inlets and outlets of the secondary fluid tubes are located on a second set of external faces of the heat exchanger which does not overlap with the first set.

7. A heat exchanger according to claim 6, wherein:
the plurality of primary fluid tubes or the plurality of secondary fluid tubes comprises a first set of fluid tubes;
the other of the plurality of primary fluid tubes or the plurality of secondary fluid tubes comprises a second set of fluid tubes;
the first set of fluid tubes are each straight and parallel to each other when passing through the heat exchanger;
the second set of fluid tubes each have an elongate section which is straight and parallel to the first set of fluid tubes, and inlet and outlet sections which are perpendicular to the first set of fluid tubes.

8. A heat exchanger according to claim 1, wherein the primary fluid tubes and/or the secondary fluid tubes are formed from steel.

9. A heat exchanger according to claim 1, wherein the primary fluid tubes and/or the secondary fluid tubes are configured to carry a molten salt, and the intervening layers are formed from a material which is resistant to corrosion by the molten salt.
